(19) United States
(12) Patent Application Publication
(10) Pub. No.: US 2006/0045394 A1
(43) Pub. Date: Mar. 2, 2006

(54) Linear guide apparatus

(75) Inventor: Jun Matsumoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 11/209,660

(22) Filed: Aug. 24, 2005

(30) Foreign Application Priority Data
Aug. 24, 2004 (JP) P. 2004-244105
Sep. 8, 2004 (JP) P. 2004-261317

(51) Int. Cl. F16C 29/06

(52) U.S. Cl. 384/44

(57) ABSTRACT

A linear guide apparatus has a guide rail having rolling element rolling face, a slider provided with rolling element rolling face on a slider body, a roller rolling between the rolling element rolling faces, a separator having a separator body and an arm portion, wherein a roller end guiding wall for guiding the roller is formed in a member other than the slider body, a distance measuring area for measuring the distance between the rolling element rolling faces on both insides of the slider body and an height measuring area for measuring the height of the rolling element rolling faces are machined together with the rolling element rolling faces, two sets of the distance measuring areas are arranged at least two positions for each of both insides of the slider body, and the height measuring area is located at least one position of the insides of the slider body.

The present invention claims foreign priority to Japanese patent applications No. P.2004-244105, filed on Aug. 24, 2004, and No. P.2004-261317, filed on Sep. 8, 2004, the contents of which are incorporated herein by reference.

### BACKGROUND OF THE INVENTION

1. Field of the Invention

The invention relates to a linear guide apparatus employed in the field of various industrial machines such as a machining tool and a measuring device.

2. Description of the Background Art

Such a kind of linear guide apparatus is known as those as shown in e.g. FIGS. 13 and 14.

This linear guide apparatus includes a guide rail 1 extending in an axial direction and a slider 2 mounted thereon so that it can move relatively in the axial direction. On both sides in the axial direction of the guide rail 1, roll rolling faces 3 extending in the axial direction are arranged as two strips for each side, respectively, and there are four stripes of the roll rolling faces in total.

On a slider body 2A of the slider 2, at the inside of each of both sleeves 4, a roll element rolling face 5 is formed oppositely to the roll element rolling face 3. These roll element rolling faces 3 and 5 constitutes a load raceway.

On the load raceway, a pluralities of cylindrical rollers serving as rolling elements are disposed rollably so that the slider 2 can move relatively along the axial direction on the guide rail 1 through the rolling of these cylindrical rollers 6.

Through this movement, the cylindrical rollers 6 existing between the guide rail 1 and slider 2 roll to reach the end in the axial direction of the slider 2. In this case, in order to continuously move the slider 2 in the axial direction, these cylindrical rollers 6 must be circulated continuously.

For this purpose, holes 7 that penetrate in the axial direction are formed within the sleeve 4 of the slider body 2A. Circulating sleeves 8, whose inside serves as a path (rolling element path) 8a of the cylindrical rollers 6, fit in the hole 7. In addition, end caps 9 are fixed to both ends of the slider body 2A via screws, respectively so that an arc-curved direction converting path 10 (FIG. 14) is formed on each end cap 9 to communicate the load raceway with the rolling element path 8a, thus making the continuously circulating raceway of the cylindrical rollers 6.

Meanwhile, the pluralities of cylindrical rollers 6 circulating continuously rotate in the same direction around a roller axis. Therefore, where the adjacent cylindrical rollers 6 are brought into contact with each other, the directions of the roller speed at a contact area are opposite to each other. Thus, the force generated in such the manner obstructs the smooth rolling of the cylindrical rollers 6.

Further, since the cylindrical rollers 6 are used as the rolling elements, the rigidity and load capability become higher than in the case of using balls. However, this causes the axis fluctuation of the cylindrical rollers 6 during running, so called skew.

In view of such a circumstance, it has been proposed that a separator 20 is arranged between the adjacent cylindrical rollers 6 to prevent direct contact between the cylindrical rollers and suppress the above skew so that running of the slider 2 is made smooth and noise is reduced during the running.

The separator 20 includes a separator body 21 located between the adjacent cylindrical rollers 6 and an arm 22 formed integrally with the separator body 21 so as to sandwich both end faces in the axial direction of the cylindrical rollers 6. At an area of the separator body 21 opposite to the outer periphery of the cylindrical roller 6, a concave shape according to the outer peripheral shape of the cylindrical rollers 6 is formed.

Incidentally, in FIG. 13, reference numeral 23 denotes a holder arranged along the load raceways in which both ends in the axial direction are inserted in end caps 9. The holder serves as a separator guiding member. Reference numeral 25 denotes one of brim portions each of which is machined integrally with the rolling element rolling face 5 at each of both insides of the slider body 2A and has a roller end guiding wall to guide the end in the axial direction of each the cylindrical rollers 6 along the circulating direction of the cylindrical rollers 6.

Where the cylindrical rollers 6 circulate along the load raceway between both rolling element rolling faces 3, 5, direction converting path 10 and roller path 8a, the arm 22 of the separator 20 is guided along the circulating direction of the cylindrical rollers 6 by a guiding groove 24 formed on the holder 23, roller path 8a and direction converting path 10, respectively.

Meanwhile, in the liner motion guide bearing device using the rollers as the rolling elements, it is necessary to precisely manage the distance between the left and right rolling element rolling faces 5 of the slider body 2A. If the distance between the left and right rolling element rolling faces 5 is smaller than a prescribed value, a preload becomes too great so that the life may be shortened. Inversely, the preload is too small so that required rigidity cannot be given.

Further, it is also necessary to manage precisely the height of the rolling element rolling faces 5 of the slider body 2a. If the height of the rolling element rolling faces 5 fluctuates, when the slider 2 is combined with the guide rail 1, the height from the bottom of the guide rail 1 to the top of the slider 2 will change so that the attaching dimension of the linear guide apparatus cannot be kept in a required clearance.

Further, in order to eliminate one side contact of the cylindrical rollers 6 to prevent the life from being shortened, it is also necessary to manage the inclination quantity of the rolling element rolling faces 5.

A method as shown in FIG. 15 is conventionally known as a method for measuring the distance between the rolling faces, height thereof and inclination quantity thereof.

In this measuring method, two sets of upper and lower of pairs of left and right V-shape grooves 26 are formed. With auxiliary members (cylinders or balls) 27 each having a known diameter being fixed in these grooves 26, upper and lower distances W1 and W2 between the rolling faces are measured. The rolling face inclination quantity can be acquired by the measured values of W1 and W2 and a known vertical pitch P between the auxiliary members 27.

By placing the slider body 2A on a reference plane such as a stool, the height H of the rolling face can be measured as a distance from the reference plane to the upper end of the auxiliary member 27. The respective dimensions are measured using an ordinary measuring apparatus such as a Passameter or dial gauge.

By precisely managing the values such as W1, W2 and H, necessary rigidity can be assured, the attaching dimension of the linear guide apparatus can be kept in the required clearance, and the one side contact of the cylindrical rollers 6 can be eliminated to prevent the life from being shortened.

In the above linear guide apparatus, for the purpose of improving the operability, as described above, the separator 20 might be disposed between the adjacent cylindrical rollers 6. In this case, referring to FIG. 13, the brim portions 25 formed on the slider body 2A are used in load regions as the inside faces in the axial direction of the guiding grooves 24 which guide the arms 22 of the separators 20 along the circulating direction of the cylindrical rollers 6. So the height of the brim portions 25 must be decreased in order to assure the space of the guiding grooves 24. Thus, the depth of the V-shape grooves 26 formed by the brim portions 25 of the slider body 2A and the rolling element rolling faces 5 become shallow so that the diameter of the auxiliary members 27 fixed to the grooves 26 must be decreased. This makes it troublesome handle the auxiliary member 27, thus leading to a disadvantage of lengthening of the measuring time.

Further, the distance between the rolling faces, rolling thereof and inclination thereof can also be measured using a three-dimensional measuring instrument. However, fixing of the device on a stand of the measuring instrument is troublesome so that a long time is taken for measurement and skill is required to operate the measuring instrument.

A previously known linear guide apparatus is also described in Japanese Patent Unexamined Publication JP-A-5-280537. This linear guide apparatus, as shown in FIGS. 27A and 27B, includes a guiding rail 101 and a slider 102. On each of the left and right sides of the guiding rail 101, two rail-side rolling element raceway faces 105 are formed with an inclination angle of 45° relative to the upper and lower surfaces of the guiding rail 101, respectively.

Such a linear guide apparatus has an advantage that it is higher in rigidity than the device using balls as the rolling elements and so can increase a load charge resistance. However, if the inclination angle of the raceway faces 106 deviates from a permissible range, the cylindrical rollers 108 make one side contact. So it is necessary to measure the inclination angle of the raceway faces 106 to examine whether or not it is within a permissible range.

In order to measure the inclination angle of the raceway faces, conventionally, a technique as shown in FIG. 28 has been generally adopted in which with a coupling member 110 hung over the insides of the slider 102, the inclination angle of the raceway faces 106 is measured by a shape measuring machine 111. However, this technique is problematic in that it takes a long time to fix the machine 111 on a stand and requires skill to operate the machine 111. In order to obviate such an inconvenience, an alternative technique as shown in FIG. 29 has been proposed. In this technique, rod-like members 113 are pressed on brims 112 provided on the insides of the slider 102 so as to be adjacent to the slider-side rolling element raceway faces 106. In this state, the dimensions W1, W2 and h between the rod-like members 113 are measured using e.g. a Passameter. On the basis of the measured values, the inclination angle of the slider-side rolling element raceway faces 106 is acquired.

However, in the technique described above, in order to precisely measure the inclination angle of the slider-side rolling element rolling faces 106, the rod-like members 113 which are small in diameter must be used, and it is difficult to deal with the rod-like members 113. So there is a problem that skill is required to measure the inclination angle of the slider-side rolling element raceway faces 106. In addition, it is necessary to provide the brims 112 on the insides of the slider 102. Thus, the shape of the insides of the slider 102 becomes a complicate shape or the brims 112 may be excessively heated in quenching resulting this, quenching hardness becomes non-uniform. Further, in grinding machining of the raceway faces 106, a part of a grinding stone may fall, thereby making it impossible to grind the raceway faces 106 appropriately. Furthermore, in the coupling areas between the brims and the raceway faces, their corner R₆ must be made smaller than R₈ of the roller ends. Therefore, the grinding stone for grinding the rollers substantially makes a sharp edge (see FIGS. 27A and 27B). This portion is likely to break, thereby reducing the machining efficiency.

### SUMMARY OF THE INVENTION

The invention has been accomplished to obviate such an inconvenience. One of objects of the invention is to provide a linear guide apparatus capable of measuring precisely and easily a distance between rolling faces, height thereof and inclination quantity thereof without skill.

In order to achieve the object, according to a first aspect of the present invention, there is provided a linear guide apparatus, comprising:
a guide rail having rolling element rolling faces extending in an axial direction on both outsides thereof;
a slider mounted on the guiding rail so as to be movable relatively along an axial direction by means of rolling of a pluralities of rollers serving as rolling elements inserted in a load raceway formed between the rolling element rolling faces of the guide rail and rolling element rolling faces of the slider, the slider including:
   a slider body having the rolling element rolling faces on respective inside thereon so as to oppose to the rolling element rolling faces of the slider, respectively, and a rolling element path penetrating in the axial direction thereof, and;
   an end cap having a curved direction inverting path communicating the load raceway and the rolling element path and fixed to the end in the axial direction of the slider body; and
a separator including:
   a separator body disposed between the rollers which is adjacent to each other; and
   an arm portion arranged to face at least one end in the axial direction of the roller and formed integrally to the separator body,
wherein a roller end guiding wall for guiding the end in the axial direction of each of rollers along the circulating direction of the rollers is formed in a member other than the slider body,
a distance measuring area for measuring the distance between the rolling element rolling faces on respective insides of the slider body and an height measuring area for measuring the height of the rolling element rolling faces are machined together with the rolling element rolling faces,
two sets of the distance measuring areas are arranged at least two positions for respective insides of the slider body, and
the height measuring area is located at least one position of the insides of the slider body.

According to a second aspect of the present invention, there is provided a linear guide apparatus, comprising:
a guide rail having rolling element rolling faces extending in an axial direction on both outsides thereof;
a slider mounted on the guiding rail so as to be movable relatively along an axial direction by means of rolling of a pluralities of rollers serving as rolling elements inserted in a load raceway formed between the rolling element rolling faces of the guide rail and rolling element rolling faces of the slider, the slider including:
   a slider body having the rolling element rolling faces on respective inside thereon so as to oppose to the rolling element rolling faces of the slider, respectively, and a rolling element path penetrating in the axial direction thereof, and;
   an end cap having a curved direction inverting path communicating the load raceway and the rolling element path and fixed to the end in the axial direction of the slider body; and
a separator including:
   a separator body disposed between the rollers which is adjacent to each other; and
   an arm portion arranged to face at least one end in the axial direction of the roller and formed integrally to the separator body,
wherein a roller end guiding wall for guiding the end in the axial direction of each of rollers along the circulating direction of the rollers is machined as a brim portion machined together with the rolling element rolling faces on both insides of the slider body,
wherein a distance measuring area for measuring the distance between the rolling element rolling faces on both insides of the slider body and a height measuring area for measuring the height of the rolling element rolling faces are machined together with the rolling element rolling faces at positions separate from the brim portions,
two sets of the distance measuring areas are arranged at least two positions for respective insides of the slider body, and
the height measuring area is located at least one position of the inside of the slider body.

According to third and fourth aspects of the present invention, as set forth in the first and second aspects of the present invention, it is preferable that at least one of the areas for measuring the distance between the rolling faces is a V-shape groove employed as the height measuring area.

According to fifth and sixth aspects of the present invention, as set forth in the first and second aspects of the present invention, it is preferable that at least one set of the distance measuring areas is a pair of plane areas.

According to seventh and eighth aspects of the present invention, as set forth in the first and second aspects of the present invention, it is preferable that the load raceways are organized as a total of four strips so that an upper load raceway and a lower raceway are arranged on each one side of the slider, respectively and
an upper rolling element path and a lower rolling element path are arranged on each one side of the slider, respectively, so that the rolling element paths are organized as four paths in total and
at least one set of the distance measuring areas is a pair of V-shape grooves arranged between the upper and lower rolling element rolling faces of the slider.

According to ninth and tenth aspects of the present invention, as set forth in the first and second aspects of the present invention, it is preferable that the height measuring area is adapt to detachably fix an auxiliary member, which is a cylinder or ball having a diameter of 2 mm or more.

According to an eleventh aspect of the present invention, there is provided a linear guide apparatus, comprising:
a guiding rail including a rail-side rolling element raceway face formed thereon;
a slider including a slider-side rolling element raceway face which is opposite to the rail-side rolling element raceway face; and
a pluralities of cylindrical rollers which roll on the rail-side rolling element raceway face and the slider-side rolling element raceway face according to relative linear motion of the slider,
wherein a guiding face for guiding both end faces of each of the cylindrical rollers are formed as a body separate from the slider-side rolling element raceway faces,
reference areas which are grinding-machined together with the slide-side rolling element raceway faces on both insides of the slider are provided adjacently to the slider-side rolling element raceway faces.

According to a twelfth aspect of the present invention, as set forth in the eleventh aspect of the present invention, it is preferable that each of the reference areas is a V-shape groove, and a coupling area for preventing an abrupt angular change is formed on a bottom of the V-shape groove.

According to a thirteenth aspect of the present invention, as set forth in the eleventh aspect of the present invention, it is preferable that each of the reference areas is a V-shape groove, and an opening angle of the V-shape groove is larger than 90°.

According to a fourteenth aspect of the present invention, there is provided a linear guide apparatus, comprising:
a guiding rail including a rail-side rolling element raceway face formed thereon;
a slider including a slider-side rolling element raceway face which is opposite to the rail-side rolling element raceway face; and
a pluralities of cylindrical rollers which roll on the rail-side rolling element raceway face and the slider-side rolling element raceway face according to relative linear motion of the slider,
wherein a substantially V-shaped groove having a bottom face which is plane or R portion of which curvature is larger than that of a chamfered portioned formed on an edge of the cylindrical roller in an axial direction, and
the V-shaped groove is formed on an inside of the slider by grinding machining together with the slider-side rolling element raceway face.

According to a fifteenth aspect of the present invention, as set forth in the fourteenth aspect of the present invention, it is preferable that an opening angle of the V-shaped groove, which is defined between faces adjacent to the bottom face, is larger than 90°.

According to a sixteenth aspect of the present invention, as set forth in the fourteenth aspect of the present invention, it is preferable that two sets of the V-shaped grooves are arranged on two positions of the respective insides of the slider.

According to a seventeenth aspect of the present invention, as set forth in the fourteenth aspect of the present invention, it is preferable that a roller end guiding wall for guiding the end in the axial direction of each of rollers along the circulating direction of the rollers is formed in a member other than the slider body.

According to the first aspect of the present invention, a roller end guiding wall for guiding the end in the axial direction of each of rollers along the circulating direction of the rollers is formed in a member other than the slider body; a distance measuring area for measuring the distance between the rolling element rolling faces on both insides of the slider body and a height measuring area for measuring the height of the rolling element rolling faces are machined integrally with the rolling element rolling faces, the distance measuring areas are arranged at least two positions for each of both insides of the slider body to thereby make two sets of the distance measuring areas, and the height measuring area is located at least one position of the insides of the slider body. In accordance with this configuration, the distance between the rolling faces, height thereof and inclination quantity thereof can be easily measured.

In the second aspect of the present invention, the distance measuring area and a height measuring area are machined integrally with the rolling element rolling faces at positions separate from the brim portions, the distance measuring areas are arranged at least two positions for each of both insides of the slider body to thereby make two sets of the distance measuring areas, and the height measuring area is located at least one position of the insides of the slider body. In accordance with this configuration, regardless of the depth of the grooves formed by the brim portions and the rolling element rolling faces, the distance between the rolling faces, height thereof and inclination quantity thereof can be easily measured.

In the third and forth aspects of the present invention, at least one of the distance measuring areas is a V-shape groove employed as the height measuring area. In accordance with this configuration, necessity of providing the height measuring area on a position other than a position on which the distance measuring area is eliminated. For this reason, the slider can be formed in a shape that is small and simple.

In the fifth and sixth aspects of the present invention, since at least one set of the areas for measuring the distance between the rolling faces is a pair of plane areas, the shape of the slider can be simplified.

In the seventh and eighth aspects of the present invention, the load raceways are organized as a total of four strips so that an upper load raceway and a lower raceway are arranged on each one side of the slider, an upper rolling element path and a lower rolling element path are arranged on each one side of the slider, respectively, so that the rolling element paths are organized as four paths in total and at least one set of the distance measuring areas is a pair of V-shape grooves arranged between the upper and lower rolling element rolling faces of the slider. In accordance with this configuration, the slider can be formed in a shape that is small and simple.

In the ninth and tenth aspects of the present invention, an auxiliary member that is a cylinder or ball having a diameter of 2 mm is detachably fixed to the area for measuring the height of the rolling faces. In accordance with this configuration, measurement with high accuracy can be made without accurate alignment between the auxiliary member and the measuring instrument, thereby permitting the height of the rolling faces to be measured easily and accurately.

According to the eleventh aspect of the present invention, it is not necessary to use the rod-like members which are small in diameter in measuring the inclination angle of the slider-side rolling element raceway faces. So without any skill, the inclination angle of the slider-side rolling element raceway faces can be measured. Further, it is not necessary to provide the brims on the insides of the slider so that the insides of the slider can be formed in a relatively simple shape and the sharp edge of the grinding stone can be prevented, thereby suppressing an increase in machining cost. Furthermore, the reference areas can be formed on the insides of the slider so that they are integral to the slider-side rolling element raceway faces. For this reason, the inclination angle of the slider-side rolling element rolling faces can be measured accurately, thereby preventing the one side contact of the cylindrical rollers.

### BRIEF DESCRIPTION OF THE DRAWINGS

FIG. 1 is a partially exploded view of the linear guide apparatus according to a first embodiment of the invention;

FIG. 2 is a sectional view of the main part of a slider;

FIG. 3 is a view for explaining the method for measuring a distance between rolling faces, the height thereof and an inclination quantity thereof;

FIG. 4 is a view for explaining a method for machining the rolling element rolling faces, the distance measuring area and a height measuring area in both insides of a slider body;

FIG. 5 is a view for explaining the machining of a grind stone by a dresser;

FIG. 6 is a view for explaining the method for measuring the height of the rolling face;

FIG. 7 is a view for explaining the method for measuring the height of the rolling face;

FIG. 8 is a graph showing the relationship between the curvature of an auxiliary member and a permissible measuring range;

FIG. 9 is a view showing an modification of a V-shape groove;

FIG. 10 is a partially exploded view of the linear guide apparatus according to a first embodiment of the invention;

FIG. 11 is a sectional view of the main part of a the slider.

FIG. 12 is a view for explaining the method for measuring a distance between rolling faces, the height thereof and an inclination quantity thereof;

FIG. 13 is a partially exploded view of a conventional linear guide apparatus;

FIG. 14 is a sectional view of the main part of a slider;

FIG. 15 is a view for explaining the method for measuring a distance between rolling faces, the height thereof and an inclination quantity thereof in the conventional linear guide apparatus;

FIG. 16 is a perspective view of a linear guide apparatus according to a third embodiment of the invention;

FIG. 17 is a front view of the linear guide apparatus shown in FIG. 16;

FIG. 18 is a front view of the slider shown in FIG. 17;

FIG. 19 is an enlarged view of region A shown in FIG. 18;

FIG. 20 is a view showing a grinding stone which is used for grinding-machining the slider-side raceway faces shown in FIG. 18;

FIG. 21 is a view showing the method for measuring the inclination angle of the slider-side raceway faces shown in FIG. 18;

FIG. 22 is a view showing a grinding tool used for making the grinding stone shown in FIG. 20;

FIG. 23 is a view showing a modification of a coupling segment shown in FIG. 19;

FIG. 24 is a front view of the slider of a linear guide apparatus according to a fourth embodiment of the invention;

FIG. 25 is a partial front view of the slider;

FIG. 26 is a front view of the slider of a linear guide apparatus according to a fifth embodiment of the invention;

FIGS. 27A and 27B are partial sectional views of a conventional linear guide apparatus using cylindrical rollers serving as rolling elements;

FIG. 28 is a view for explaining an example of the method for measuring the inclination angle of the slider-side raceway faces; and

FIG. 29 is a view for explaining another example of the method for measuring the inclination angle of the slider-side raceway faces.

### DETAILED DESCRIPTION OF THE PREFERRED EMBODIMENTS

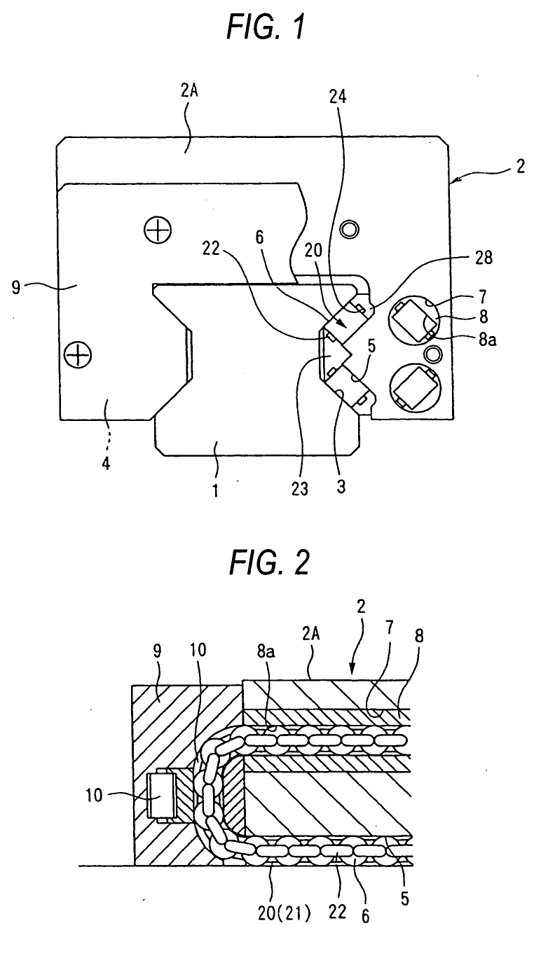

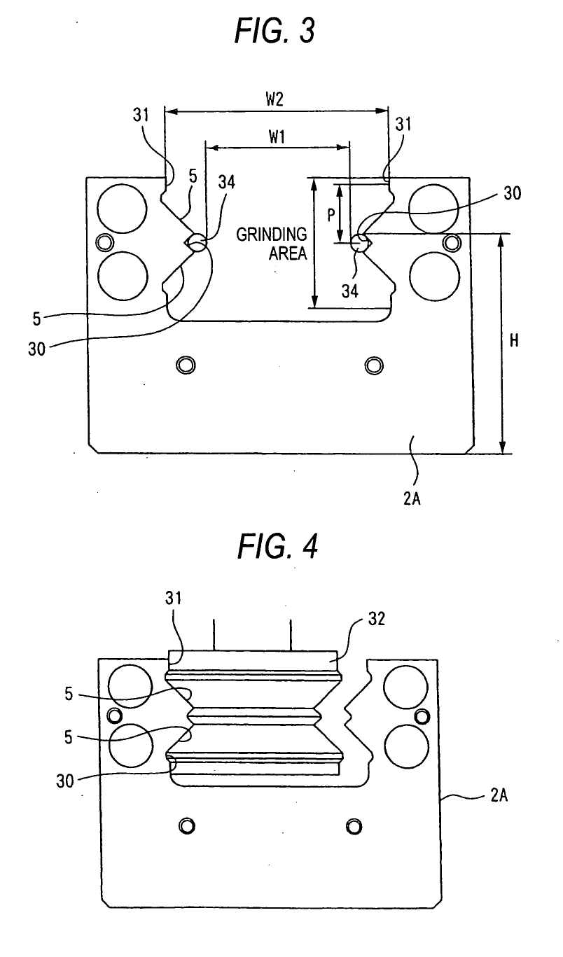

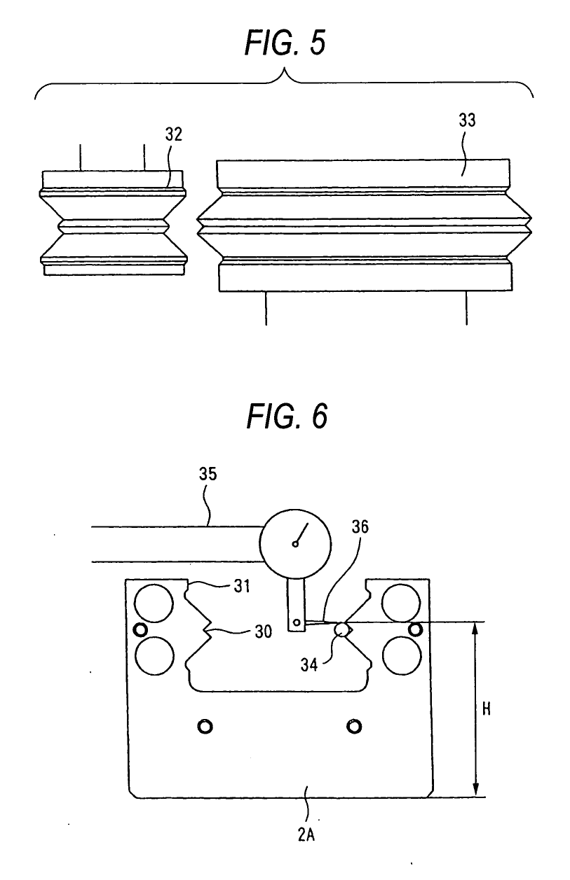

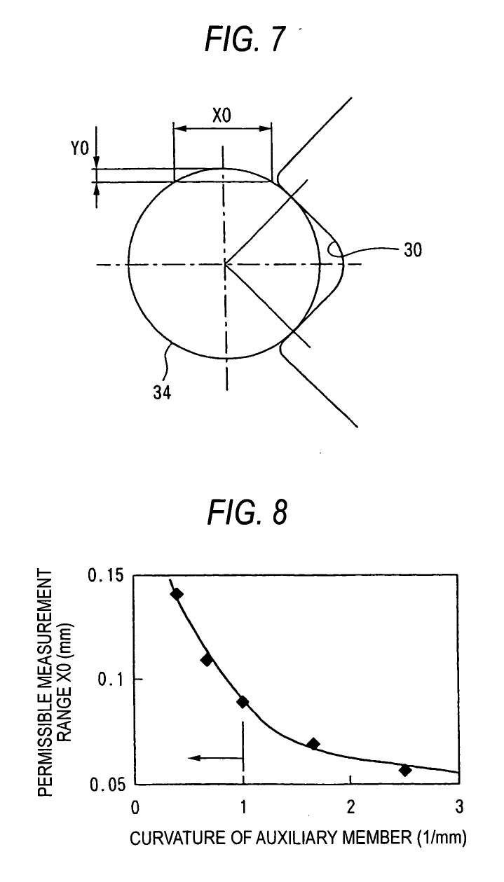

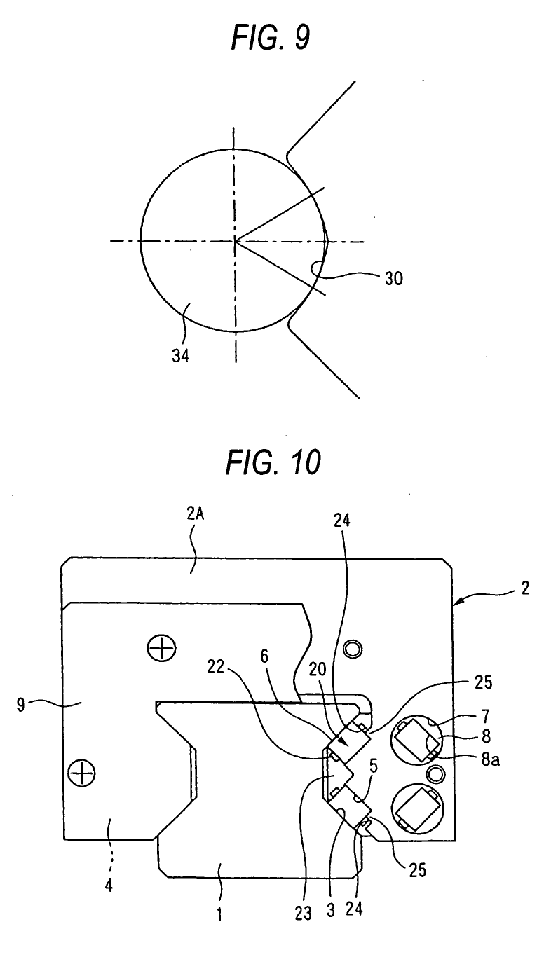

Now referring to the drawings, an explanation will be given of an embodiment of the invention. FIG. 1 is a partially exploded view of the linear guide apparatus according to an embodiment of the invention. FIG. 2 is a sectional view of the main part of a slider. FIG. 3 is a view for explaining the method for measuring a distance between rolling faces, the height thereof and an inclination quantity thereof. FIG. 4 is a view for explaining a method for machining the rolling element rolling faces, a distance measuring area and a height measuring area in both insides of a slider body. FIG. 5 is a view for explaining the machining of a grind stone by a dresser. FIGS. 6 and 7 are views for explaining the method for measuring the height of the rolling face. FIG. 8 is a graph showing the relationship between the curvature of an auxiliary member and a permissible measuring range. FIG. 9 is a view showing an modification of a V-shape groove. FIGS. 10 to 12 are views for explaining the linear guide apparatus according to a second embodiment of the invention.

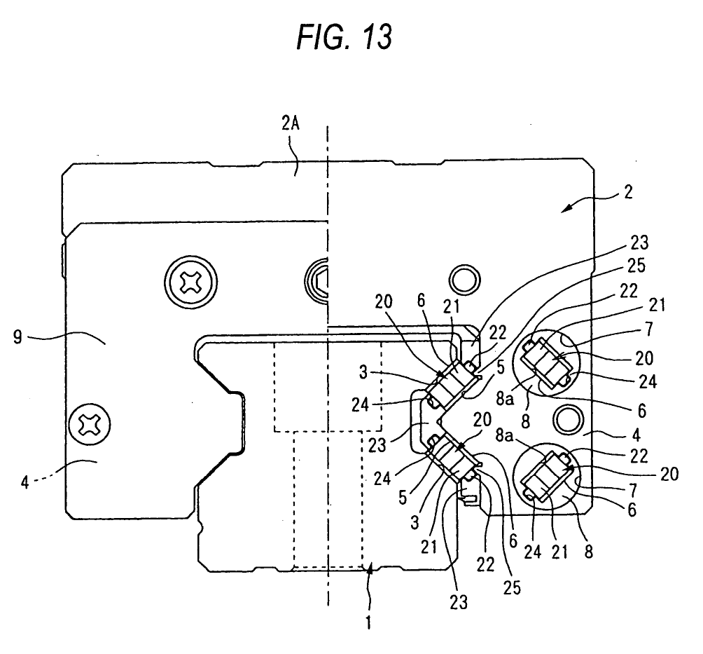

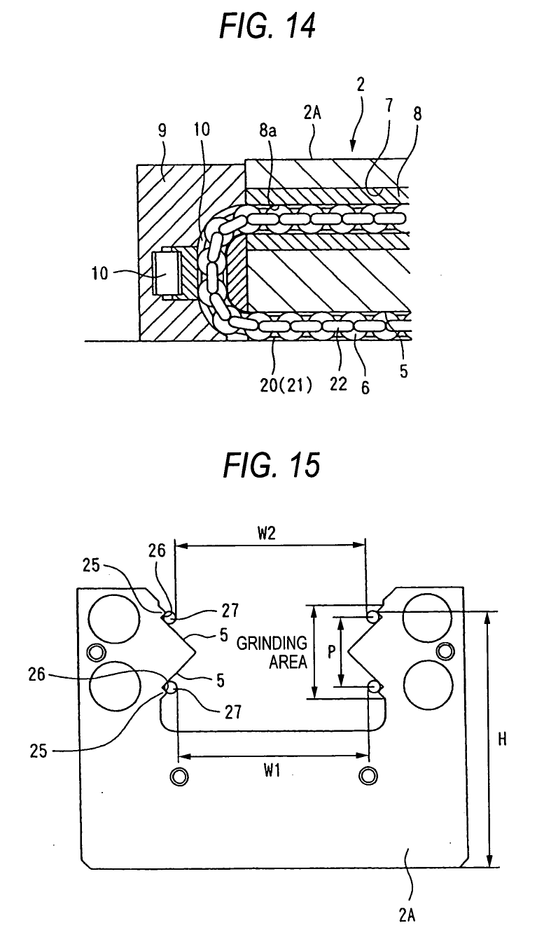

As regards the respective embodiments, only a difference from the conventional linear motion guide bearing, which is shown in FIGS. 13 to 15, will be explained. The members equivalent or corresponding to those in FIGS. 13 to 15 are indicated by the same reference symbols as in the respective figures and the explanations thereof are omitted.

In the linear guide apparatus according to the first embodiment of the invention, as shown in FIGS. 1 and 2, roller end guiding walls 28 for guiding the ends in the axial direction of the cylindrical rollers 6 along the circulating direction of the cylindrical rollers 6 is formed in the holder 23 which is a member other than the slider body. A guiding groove of the arm 22 of the separator 20 on the load raceway between the rolling element rolling faces 3, 5 is formed in only the holder 23. The roller end guiding walls 28 constitute a part of the guiding grooves 24. Thus, no brim portion is formed on the slider body 2A.

In this embodiment, as shown in FIG. 3, the distance measuring areas for measuring the distances W1 and W2, which are defined between the rolling element rolling faces 5, are arranged at two positions on both insides of the slider body 2A, respectively, this is, there are two sets of the distance measuring areas in total. The one set of the distance measuring areas are machined as a pair of V-shaped grooves 30 between the upper and lower rolling element rolling faces 5, and integrally formed with the upper and lower rolling element rolling faces 5. The other set of distance measuring areas are machined as a pair of plane areas 31 at the lower regions (upper regions in FIG. 3) integrally with the lower rolling element rolling faces 5.

Incidentally, the rolling element rolling faces 5, V-shaped grooves 30 and planar areas 31 are formed by grinding using a grind stone 32 as shown in FIG. 4. The grind stone 32 is shaped by a dresser 33 as shown in FIG. 5.

Further, in this embodiment, one of the pair of V-shape grooves 30 is also employed as a height measuring are for measuring the height H of the rolling element rolling faces 5. Auxiliary members 34 which are a cylinder or ball having a diameter of 2 mm or more is detachably attached to each of the pair of V-shape grooves 30. Incidentally, the V-shaped grooves 30 may include a Gothic arch shape as shown in FIG. 9 as well as a combination of planes as shown in FIG. 7.

Followings are explanations of measurement of the distances W1, W2 between the rolling faces, height H thereof and inclination quantity θ thereof. An ordinary measuring instrument such as a passameter or dial gauge is used. The distance between the auxiliary members 34, whose diameter are known and fixed to the pair of V-shape grooves 30, is measured as distance W1 which is defined between the rolling faces. The distance between the pair of plane areas 31 is measured as distance W2. The quantity θ of the rolling faces can be acquired by calculation on the basis of the measured values of W1 and W2 and a known vertical pitch P between the auxiliary member 34 and planar area 31.

By placing the slider body 2A on a reference plane such as a stool, the height H of the rolling faces can be measured as a distance from the reference plane to the upper end of the auxiliary member 34 (see FIG. 6). In this case, as shown in FIG. 7, in order to maintain measuring accuracy (permissible error) of the height of raceway face H within the a range of Y0, it is required to adjust a position of stylus 36 shown in FIG. 6 of the measuring instrument 35 within an area of a permissible measuring range X0. To make X0 smaller, the higher the positional accuracy is required, thereby making difficult the measurement.

FIG. 8 is a graph showing the relationship between the curvature of the auxiliary members 34 (reciprocal of the radius of the auxiliary members 34) and the permissible measuring range X0 assuming that Y0 is 1 μm in the linear guide apparatus according to this embodiment.

This shows that if the curvature of the auxiliary members 34 is made less than 1 (unit: 1/mm), the permissible measuring range can be extended greatly as compared with the case where the curvature is larger. Thus, it is preferable that the curvature is less than 1 (unit: 1/mm). In other words, the shape of the V-shape grooves 30 is set as the raceway face height so that the auxiliary members 34 having a diameter of 2 mm or more can be fixed.

As described above, in this embodiment, the roller end guiding walls 28 for guiding the ends in the axial direction of the cylindrical rollers 6 along the circulating direction of the cylindrical rollers 6 is formed on the holder 23. Without providing the brim portions 25 on the slider 2A, the distance measuring areas for measuring the distances W1 and W2 between the rolling element rolling faces 5 of both insides of the slider body 2A are arranged at two positions on both insides of the slider body 2A, respectively. That is, there are two sets of the distance measuring areas in total. The one set of the distance measuring area are machined as a pair of V-shaped grooves 30 between and integrally with the upper and lower rolling element rolling faces 5. The other set of distance measuring areas are machined as a pair of plane areas 31 at the lower regions of the lower rolling element rolling faces 5 (upper regions in FIG. 3) integrally to the lower rolling element rolling faces 5. Further, one of the pair of substantially V-shape grooves 30 is also employed as the height measuring area for measuring the height H of the rolling element rolling faces 5. In accordance with such a configuration, the distances W1, W2 between the rolling faces, height H thereof and inclination quantity θ thereof can be measured precisely and easily.

One of the pair of V-shape grooves 30 is also employed as the height measuring area for measuring the height H of the rolling element rolling faces 5. So, necessity of providing the height measuring area in addition to the distance measuring area is eliminated. For this reason, the slider 2 can be formed in a shape that is small and simple.

The one of two sets of distance measuring areas is the pair of V-shape grooves 30 which are arranged between the upper and lower rolling element rolling faces 5. For this reason, the slider 2 can be formed in a shape which is small and simple.

Further, the other of the two sets of distance measuring areas is formed as the pair of planes 31. For this reason, the shape of the slider body 2A can be simplified.

Further, since the auxiliary members 34 which are a cylinder or ball having a diameter of 2 mm or more can be detachably fixed in the V-shape grooves 30 which are employed as the height measuring area, measurement with high accuracy can be made without accurate alignment between the auxiliary members 34 and the measuring instrument 35, thereby permitting the height H of the rolling faces to be measured easily and accurately.

Next, referring to FIGS. 10 to 12, an explanation will be given of the linear guide apparatus according to the second embodiment of the invention.

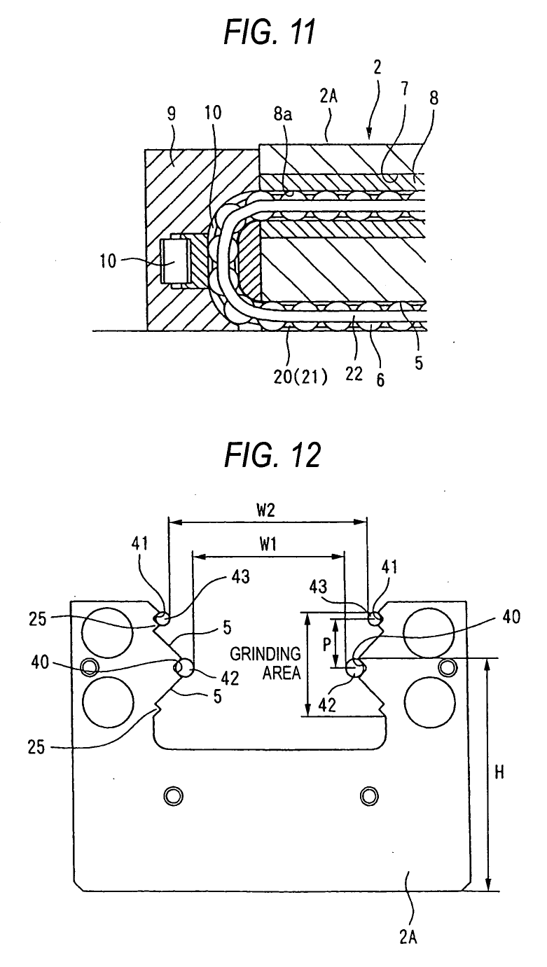

In the linear guide apparatus according to the second embodiment of the invention, as shown in FIGS. 10 and 11, in each of both insides of the slider body 2A, roller end guiding walls for guiding the ends in the axial direction of the cylindrical rollers 6 along the circulating direction of the cylindrical rollers 6 is machined as brim portions 25 integrally to the rolling element rolling faces 5. The brim portions 25 are employed as inside faces in the width direction of the guiding grooves 24 for guiding the arms 22 of the separators 20 along the circulating direction of the cylindrical rollers 6 in the load region. The arms 22 of the separators 20 are coupled with each other to form a belt.

In this embodiment, as shown in FIG. 12, two sets of distance measuring areas for measuring the distances W1 and W2 between the rolling element rolling faces 5 on both insides of the slider 2A are arranged at two positions on both insides of the slider body 2A, respectively, that is, there are two sets of distance measuring areas in total. The one set of the areas for measuring the distance between the rolling faces are machined as a pair of V-shaped grooves 40 between the upper and lower rolling element rolling faces 5 and formed integrally with the upper and lower rolling element rolling faces at positions separate from the brim portions 25.

The other set of the areas for measuring the distance between the rolling faces are machined as a pair of V-shaped grooves 41 integrally with the lower rolling element rolling faces 5 (upper positions in FIG. 12) beneath the positions separate from the brim portions 25.

In this embodiment, one of the pair of V-shape grooves 40 is also employed as the height measuring area for measuring the height H of the rolling element rolling faces 5. Auxiliary members 42 which are a cylinder or ball having a diameter of 2 mm or more are detachably attached to the pair of V-shape grooves 40. Auxiliary members 43 which are a cylinder or ball is detachably attached to the pair of V-shape grooves 41.

Measurement of the distances W1, W2 between the rolling faces, height H thereof and inclination quantity θ thereof will be explained follow. An ordinary measuring instrument such as a Passameter or dial gauge is used. The distance between the auxiliary members 42, whose diameter is known and fixed to the pair of V-shape grooves, 40 is measured as distance W1 between the rolling faces. The distance between the auxiliary members 43, whose diameter is known and fixed to the pair of V-shape grooves 41, is measured as distance W2 between the rolling faces. The quantity θ of the rolling faces can be acquired by calculation on the basis of the measured values of W1 and W2 and a known vertical pitch P between the auxiliary members 42 and 43.

By placing the slider body 2A on a reference plane such as a stool, the height H of the rolling faces can be measured as a distance from the reference plane to the upper end of the auxiliary members 42.

As described above, in this embodiment, the distance measuring areas for measuring the distances W1 and W2 between the rolling element rolling faces 5 on both insides of the slider 2A are arranged at two positions on both insides of the slider body 2A, respectively, that is, there are two set of distance measuring areas in total. The one set of the distance measuring areas are machined as a pair of V-shaped grooves 40 between the upper and lower rolling element rolling faces 5 and integrally formed with the upper and lower rolling element rolling faces 5 at positions separate from the brim portions 25. The other set of the distance measuring areas are machined as a pair of V-shaped grooves 41 integrally with the lower rolling element rolling faces 5 (upper positions in FIG. 12) beneath the positions separate from the brim portions 25. Further, in this embodiment, one of the pair of V-shape grooves 40 is also employed as the height measuring area for measuring the height H of the rolling element rolling faces 5. Thus, regardless of the depth of the groove formed by the brim 25 and rolling element rolling face 5, the distances W1, W2 between the rolling faces, height H thereof and inclination quantity θ can be measured accurately and easily.

One substantially V-shape groove 40 of the pair of V-shape grooves 40 is also employed as the height measuring area for measuring the height H of the rolling element rolling faces 5. So, necessity of providing the height measuring area in addition to the distance measuring area is eliminated. For this reason, the slider 2 can be formed in a shape that is small and simple.

The pair of V-shape grooves 40 which is one of two sets of the distance measuring areas are arranged between the upper and lower rolling element rolling faces 5. For this reason, the slider 2 can be formed in a shape which is small and simple.

Further, since the auxiliary members 42 which are a cylinder or ball having a diameter of 2 mm or more can be detachably fixed in the V-shape grooves 40 which are employed as the height measuring area, measurement with high accuracy can be made without accurate alignment between the auxiliary members 42 and the measuring instrument, thereby permitting the height H of the rolling faces to be measured easily and accurately.

Now referring to the drawings, an explanation will be given of third through fifth embodiments of the invention.

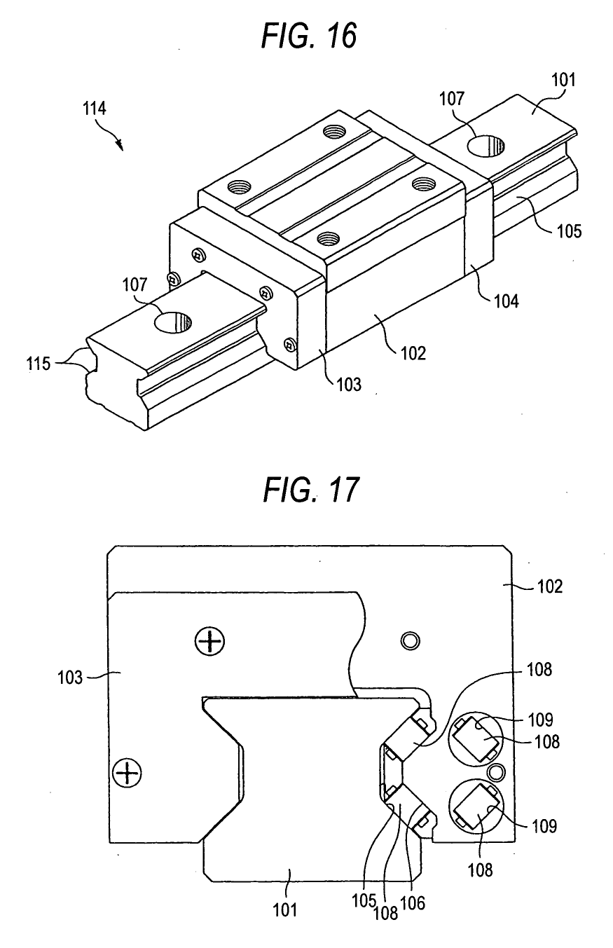

The linear guide apparatus according to a third embodiment of the invention is shown in FIGS. 16 to 19. In FIG. 16, reference numeral 114 denotes a linear guide apparatus according to the third embodiment. The linear guide apparatus 114 includes a guiding rail 101, a slider 102 and end caps 103, 104.

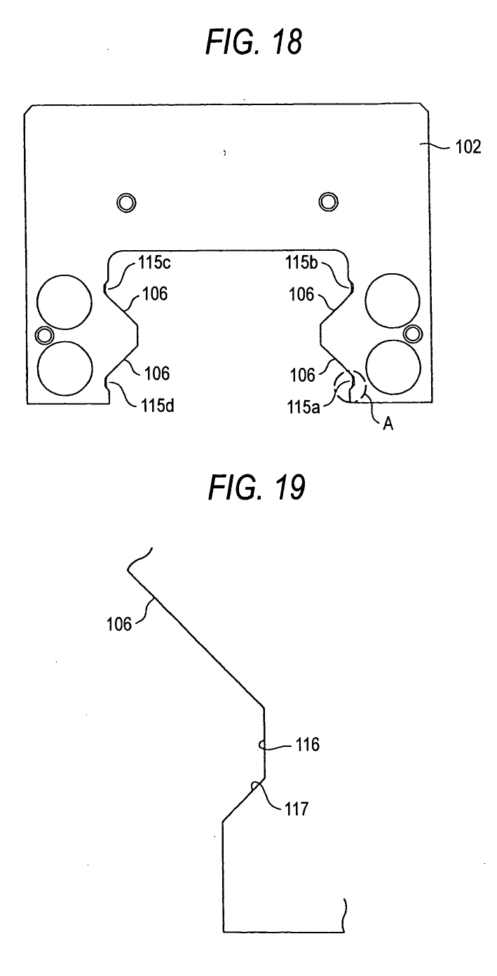

The guiding rail 101 and slider 102 are made of a metallic material such as steel. On each of the left and right sides of the guiding rail, two strips of rail-side rolling element raceway faces 105 each having an inclination angle of 45° from the upper and lower surfaces of the guiding rail 101 are formed. These rail-side rolling element raceway faces 105 are opposite to two strips of slider-side rolling element raceway faces 106 (FIGS. 17 and 18) formed on each of the insides of the slider 102. Between the rail-side rolling element raceway faces 105 and the slider-side rolling element raceway faces 106, pluralities of cylindrical rollers 108 (FIG. 17) serving as rolling elements are provided. Incidentally, on the upper surface of the guiding rail 101, a plurality of rail-attaching holes 107 are provided for fixing the lower surface of the guiding rail 101 to a machine stand by bolts (not shown).

When the slider 102 makes a relative movement in a longitudinal direction of the guiding rail 101, the cylindrical rollers 108 roll on the rail-side rolling element raceway faces 105 and the slider-side rolling element raceway faces 106. The cylindrical rollers 108 which have rolled along the slider-side rolling element faces 106 convert their direction on direction converting paths formed at e.g. an end cap 103. Thereafter, the cylindrical rollers 6 roll along rolling returning paths 109 (FIG. 17) formed on the slider 102 to return to original positions.

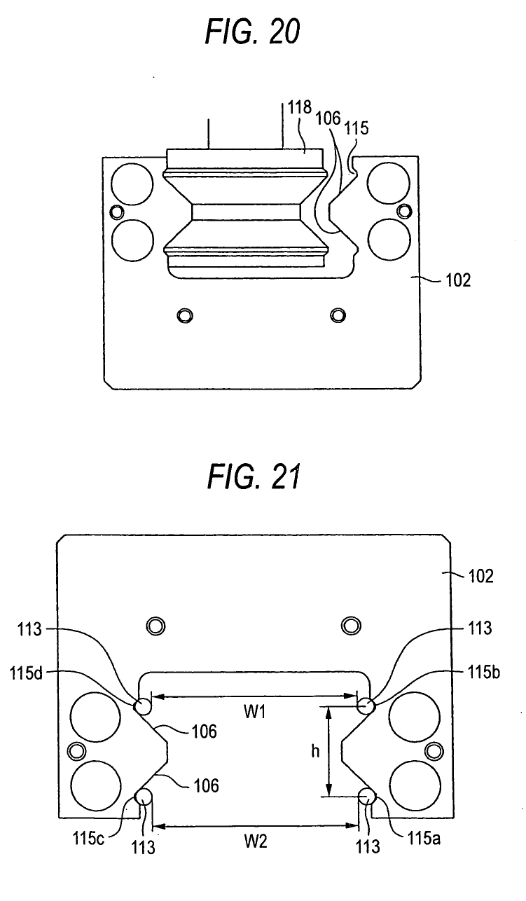

On the insides of the slider 102, reference areas 115a to 115d (FIG. 18) serving as an aid for measuring the inclination angle of the slider-side rolling element raceway faces are provided adjacently to the slider-side rolling element raceway faces 106. These reference areas 115a to 115d, as shown in FIG. 19, each is composed of the slider-side rolling element raceway face 106, a planar segment 117 and a coupling segment 116 sandwiched between the raceway face 106 and the planar segment 117. The coupling segment 116 is also planar. The coupling segments 116 and planar segments 117 are grinding-machined together with the slider-side rolling element raceway faces 106 using a form grinding stone 118 having the shape as shown in FIG. 20 so that they are formed on the insides of the slider 102. In this configuration, the coupling segments 115 and the planar segments 117 are integral with the slider-side rolling element raceway faces 106.

In this configuration, in order to measure the inclination angle of the slider-side rolling element raceway faces 106, with cylindrical rod-like members 113 pressed against the reference areas 115a to 115d formed on the insides of the slider 102, the horizontal dimensions W1, W2 between the rod-like members 113 pressed against the reference areas 115a to 115d are measured using e.g. a Passameter. Now assuming that the inclination angle of the slider-side rolling element raceway faces 106 is θ, the inclination angle θ of the slider-side rolling element raceway faces 106 is acquired from the following equation.
θ=(W1−W2)/h
h: known distance between centers of the rod-like members in design

As described above, in the third embodiment of the invention, the reference areas 115a to 115d each is composed of the slider-side rolling element raceway face 106, planar segment 117 and coupling segment 116 sandwiched between the raceway face 106 and planar segment 117. For this reason, unlike the conventional technique described above, in measuring the inclination angle of the slider-side rolling element raceway faces 106, it is not necessary to use the rod-like members 113 which are small in diameter. Thus, in measuring the inclination angle of the slider-side rolling element raceway faces 106, the inclination angle can be measured with no skill. In addition, since the coupling segments 116 are provided, the grinding stone has no sharp edge so that grinding can be easily done to improve the machining efficiency.

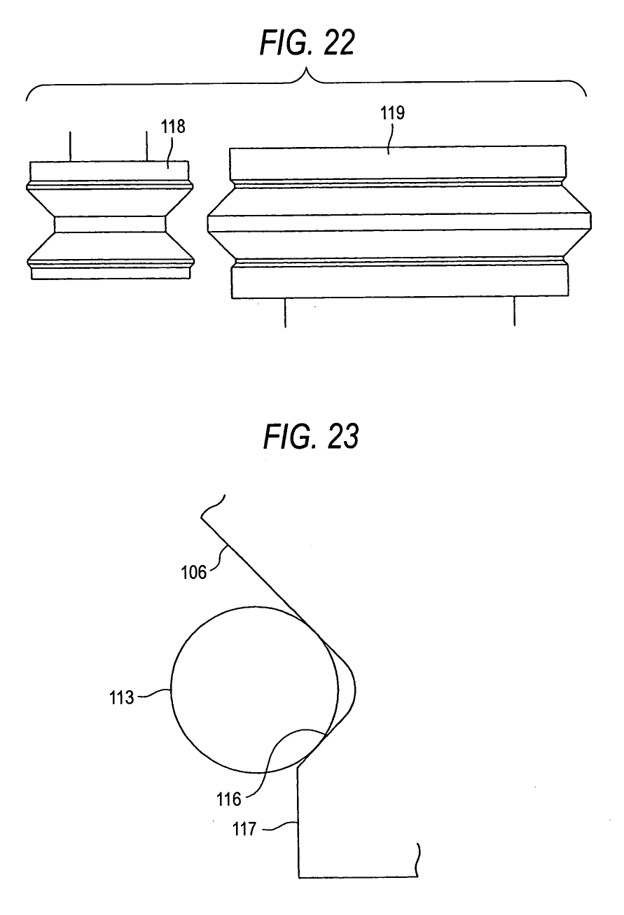

Further, it is not necessary provide the brims on the insides of the slider 102 so that the insides of the slider 102 can be formed in a relatively simple shape, thereby suppressing an increase in machining cost. Furthermore, by using a form grinding stone 118 having the shape as shown in FIG. 22 when grinding-machining the slider-side rolling element raceway faces 106, the reference areas 115a to 115d can be formed on the insides of the slider 102 so that they are integral to the slider-side rolling element raceway faces 106. For this reason, the inclination angle of the slider-side rolling element rolling faces 106 can be measured accurately, thereby preventing the one side contact of the cylindrical rollers 108. Incidentally, in FIG. 22, reference numeral 119 denotes a grinding tool (diamond dresser) for grinding-machining the grinding stone. Further, the coupling segments 116 may be formed in an arc shape to provide the same effect.

Next, referring to FIGS. 9 and 10, an explanation will be given of the fourth embodiment of the invention.

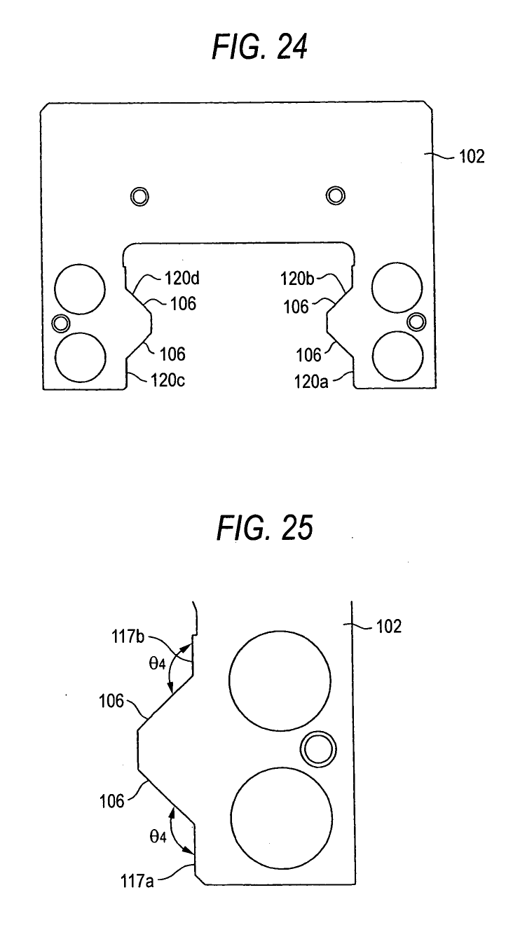

FIG. 24 is a front view of the slider of a linear guide apparatus according to the fourth embodiment of the invention. As shown in FIG. 24, on the insides of the slider 102, reference areas 120a to 120d serving as an aid for measuring the inclination angle of the slider-side rolling element raceway faces 106 are provided adjacently to the slider-side rolling element raceway faces 106. These reference areas 120a to 120d are grinding-machined together with the slider-side rolling element raceway faces 106 using a grinding stone not shown so that they are integrally formed on the insides of the slider 102. These reference areas 120a to 120d, as shown in FIG. 25, each is composed of the raceway face 106 and a planar segment 117. The raceway face 106 and planar segment 117 form an angle θ₄ of 135°.

In the fourth embodiment of the invention having the configuration described above, the opening angle θ₄ of the reference areas 120a to 120d for the slider-side rolling element raceway faces 106 is set as θ₄=135°. For this reason unlike the conventional technique described above, in measuring the inclination angle of the slider-side rolling element raceway faces 106, it is not necessary to use the rod-like members 113 which are small in diameter. Thus, in measuring the inclination angle of the slider-side rolling element raceway faces 106, the inclination angle can be measured with no skill. Further, since the opening angle of the reference areas 120a to 120d is relatively large, the edge of the grinding stone can be formed at an obtuse angle so that the grinding stone can be made difficult to break, thereby improving the machining efficiency.

Further, it is not necessary provide the brims on the insides of the slider 102 so that the insides of the slider can be formed in a relatively simple shape, thereby suppressing an increase in machining cost. Furthermore, when the slider-side rolling element raceway faces 106 are grinding-machined using the grinding stone, the reference areas 120a to 120d can be formed on the insides of the slider 102 so that they are integral to the slider-side rolling element raceway faces 106. For this reason, the inclination angle of the slider-side rolling element rolling faces 106 can be measured accurately, thereby preventing the one side contact of the cylindrical rollers 108.

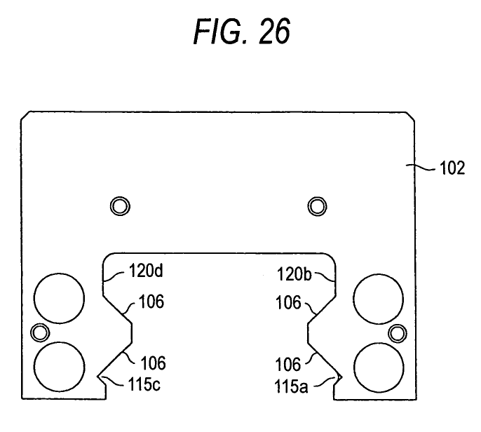

Incidentally, the invention should be not limited to the embodiments described above. For example, like the fifth embodiment as shown in FIG. 26, the reference areas 115a, 115c and the reference areas 120b, 120d may be formed in their appropriate combination on the insides of the slider 102.

Now, an explanation will be given of the sixth embodiment of the invention.

In the linear guide apparatus according to the sixth embodiment of the invention, the linear guide apparatus includes a guiding rail having a rail-side rolling element raceway face formed thereon, a slider including a slider-side rolling element raceway face which is opposite to the rail-side rolling element raceway face and a pluralities of cylindrical rollers which roll on the rail-side rolling element raceway face and the slider-side rolling element raceway face according to relative linear motion of the slider, as shown in FIGS. 18 through 20. In the linear guide apparatus, the V-shaped groove is formed on the inside of the slider by grinding machining together with the slider-side rolling element raceway face. The substantially V-shaped groove has a bottom face which is plane or R portion of which curvature is larger than that of a chamfered portioned formed on an edge of the cylindrical roller. In a case shown in FIG. 18, two sets of the V-shaped groove are formed on two positions on the one side of inside of the slider, respectively.

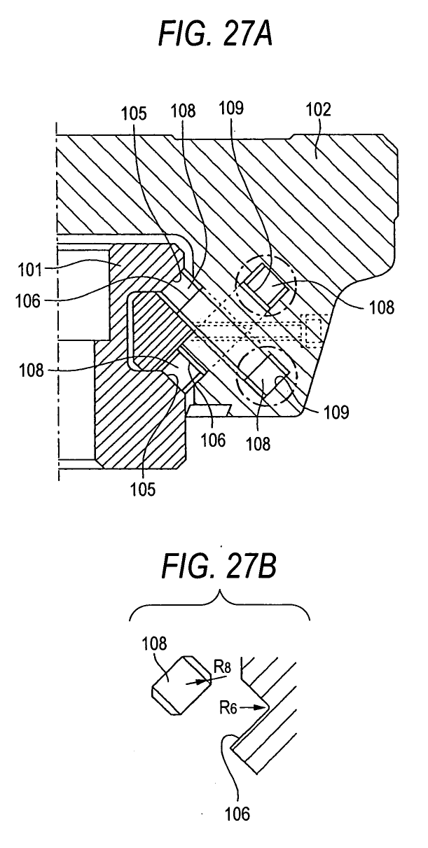

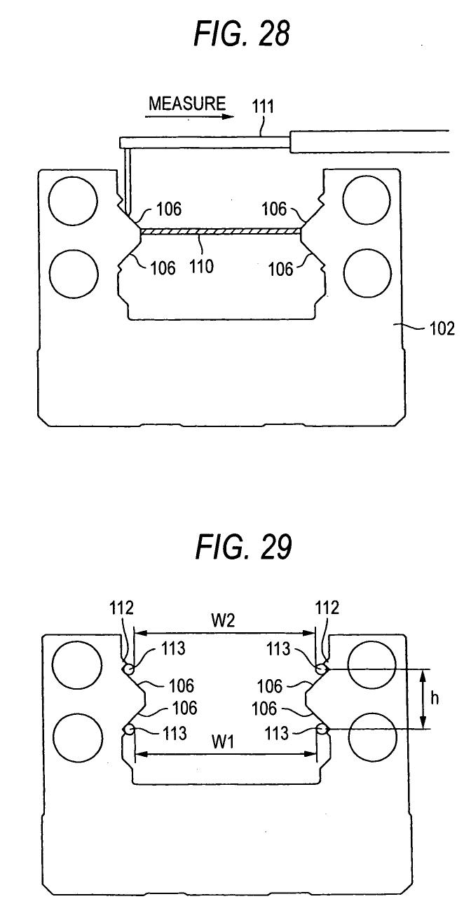

When measuring the distance or height of rolling element rolling faces, the measurement becomes easy to use V-shaped groove. However, when machining the v-shaped groove, in a case where the bottom of the V-shaped groove has a sharp edge, a part of the grind stone which machines the bottom of the V-shaped groove is easily drop off. However, in a case where the V-shaped groove has a bottom face which is plane or R portion of which curvature is larger than that of the edge of the roller (e.g., R₈ shown in FIG. 27B) as described in the sixth embodiment, the curvature of the bottom of the V-shaped groove becomes larger and the drop off becomes hardly occurred.

Further, in view of preventing the drop off of the grind stone, it is preferable that an opening of the V-shaped groove, which is defined between faces adjacent to the bottom face, is larger than 90°.

Furthermore, in order to guide the roller along the circulating direction of the roller, it is preferable to provide a roller end guiding wall on a member other than the slider.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A linear guide apparatus, comprising:
a guide rail having rolling element rolling faces extending in an axial direction on both outsides thereof;
a slider mounted on the guiding rail so as to be movable relatively along an axial direction by means of rolling of a pluralities of rollers serving as rolling elements inserted in a load raceway formed between the rolling element rolling faces of the guide rail and rolling element rolling faces of the slider, the slider including:
a slider body having the rolling element rolling faces on respective inside thereon so as to oppose to the rolling element rolling faces of the slider, respectively, and a rolling element path penetrating in the axial direction thereof; and
an end cap having a curved direction inverting path communicating the load raceway and the rolling element path and fixed to the end in the axial direction of the slider body; and
a separator including:
a separator body disposed between the rollers which is adjacent to each other; and
an arm portion arranged to face at least one end in the axial direction of the roller and formed integrally to the separator body,
wherein a roller end guiding wall for guiding the end in the axial direction of each of rollers along the circulating direction of the rollers is formed in a member other than the slider body,
a distance measuring area for measuring the distance between the rolling element rolling faces on respective insides of the slider body and an height measuring area for measuring the height of the rolling element rolling faces are machined together with the rolling element rolling faces,
two sets of the distance measuring areas are arranged at least two positions for respective insides of the slider body, and
the height measuring area is located at least one position of the insides of the slider body.

2. A linear guide apparatus, comprising:
a guide rail having rolling element rolling faces extending in an axial direction on both outsides thereof;
a slider mounted on the guiding rail so as to be movable relatively along an axial direction by means of rolling of a pluralities of rollers serving as rolling elements inserted in a load raceway formed between the rolling element rolling faces of the guide rail and rolling element rolling faces of the slider, the slider including:
a slider body having the rolling element rolling faces on respective inside thereon so as to oppose to the rolling element rolling faces of the slider, respectively, and a rolling element path penetrating in the axial direction thereof; and
an end cap having a curved direction inverting path communicating the load raceway and the rolling element path and fixed to the end in the axial direction of the slider body; and
a separator including:
a separator body disposed between the rollers which is adjacent to each other; and
an arm portion arranged to face at least one end in the axial direction of the roller and formed integrally to the separator body,
wherein a roller end guiding wall for guiding the end in the axial direction of each of rollers along the circulating direction of the rollers is machined as a brim portion machined together with the rolling element rolling faces on both insides of the slider body,
a distance measuring area for measuring the distance between the rolling element rolling faces on both insides of the slider body and a height measuring area for measuring the height of the rolling element rolling faces are machined together with the rolling element rolling faces at positions separate from the brim portions,
two sets of the distance measuring areas are arranged at least two positions for respective insides of the slider body, and
the height measuring area is located at least one position of the inside of the slider body.

3. The linear guide apparatus according to claim 1, wherein at least one of the areas for measuring the distance between the rolling faces is a V-shape groove employed as the height measuring area.

4. The linear guide apparatus according to claim 2, wherein at least one of the areas for measuring the distance between the rolling faces is a V-shape groove employed as the height measuring area.

5. The linear guide apparatus according to claim 1, wherein at least one set of the distance measuring areas is a pair of plane areas.

6. The linear guide apparatus according to claim 2, wherein at least one set of the distance measuring areas is a pair of plane areas.

7. The linear guide apparatus according to claims 1,
wherein the load raceways are organized as a total of four strips so that an upper load raceway and a lower raceway are arranged on each one side of the slider, respectively,
an upper rolling element path and a lower rolling element path are arranged on each one side of the slider, respectively, so that the rolling element paths are organized as four paths in total, and
at least one set of the distance measuring areas is a pair of V-shape grooves arranged between the upper and lower rolling element rolling faces of the slider.

8. The linear guide apparatus according to claims 2,
wherein the load raceways are organized as a total of four strips so that an upper load raceway and a lower raceway are arranged on each one side of the slider, respectively,
an upper rolling element path and a lower rolling element path are arranged on each one side of the slider, respectively, so that the rolling element paths are organized as four paths in total, and
at least one set of the distance measuring areas is a pair of V-shape grooves arranged between the upper and lower rolling element rolling faces of the slider.

9. The linear guide apparatus according to claim 1, wherein the height measuring area is adapt to detachably fix an auxiliary member, which is a cylinder or ball having a diameter of 2 mm or more.

10. The linear guide apparatus according to claim 2, wherein the height measuring area is adapt to detachably fix an auxiliary member, which is a cylinder or ball having a diameter of 2 mm or more.

11. A linear guide apparatus, comprising:
a guiding rail including a rail-side rolling element raceway face formed thereon;
a slider including a slider-side rolling element raceway face which is opposite to the rail-side rolling element raceway face; and
a pluralities of cylindrical rollers which roll on the rail-side rolling element raceway face and the slider-side rolling element raceway face according to relative linear motion of the slider,
wherein a guiding face for guiding both end faces of each of the cylindrical rollers are formed as a body separate from the slider-side rolling element raceway faces, and
reference areas which are grinding-machined together with the slide-side rolling element raceway faces on both insides of the slider are provided adjacently to the slider-side rolling element raceway faces.

12. The linear guide apparatus according to claim 11, wherein each of the reference areas is a V-shape groove, and a coupling area for preventing an abrupt angular change is formed on a bottom of the V-shape groove.

13. The linear guide apparatus according to claim 11, wherein each of the reference areas is a V-shape groove, and an opening angle of the V-shape groove is larger than 90°.

14. A linear guide apparatus, comprising:
a guiding rail including a rail-side rolling element raceway face formed thereon;
a slider including a slider-side rolling element raceway face which is opposite to the rail-side rolling element raceway face; and
a pluralities of cylindrical rollers which roll on the rail-side rolling element raceway face and the slider-side rolling element raceway face according to relative linear motion of the slider,
wherein a substantially V-shaped groove having a bottom face which is plane or R portion of which curvature is larger than that of a chamfered portioned formed on an edge of the cylindrical roller in an axial direction, and
the V-shaped groove is formed on an inside of the slider by grinding machining together with the slider-side rolling element raceway face.

15. The linear guide apparatus according to claim 14, wherein an opening angle of the V-shaped groove, which is defined between faces adjacent to the bottom face, is larger than 90°.

16. The linear guide apparatus according to claim 14, wherein two sets of the V-shaped grooves are arranged on two positions of the respective insides of the slider.

17. The linear guide apparatus according to claim 14, wherein a roller end guiding wall for guiding the end in the axial direction of each of rollers along the circulating direction of the rollers is formed in a member other than the slider.
